(19) United States
(12) Patent Application Publication
(10) Pub. No.: US 2015/0286471 A1
(43) Pub. Date: Oct. 8, 2015

(54) System and methods thereof for safe compilation of code into embedded processing systems

(71) Applicant: INTEGRITY PROJECT LTD, Ramat Gan (IL)

(72) Inventor: Elad Raz, Ramat Gan (IL)

(21) Appl. No.: 14/436,090

(22) PCT Filed: Dec. 4, 2013
(86) PCT No.: PCT/IL2013/050998

§ 371 Date: Apr. 16, 2015

Related U.S. Application Data
(60) Provisional application No. 61/733,952, filed on Dec. 6, 2012.

(51) Int. Cl. G06F 9/45; G06F 12/02

(52) U.S. Cl. CPC G06F 8/41; G06F 12/023; G06F 2212/251

(57) ABSTRACT

A method for a software development kit (SDK) operative on a computing system is provided. The method comprises receiving at least a portion of a code in a managed programming language; receiving at least memory parameters of a target processing system, wherein the memory parameters define a memory space available for a compiled code of the received code; and compiling, using the memory parameters, the received code in the managed programming language into a native code for execution by the target processing system, wherein the compiled native code is forced to execute within boundaries defined by the of memory of target system memory parameters.

### CROSS-REFERENCE TO RELATED APPLICATIONS

The present application claims priority to U.S. Ser. No. 61/733,952 filed Dec. 6, 2012, and which is incorporated herein by reference in its entirety.

### FIELD OF THE DISCLOSURE

The invention generally relates to embedded systems, and more specifically to embedded controllers and application-specific modules.

### BACKGROUND OF THE DISCLOSURE

A typical semiconductor digital chip normally includes a processing element such as a microcontroller or a microprocessor, some application-relevant elements, and some firmware stored in memory coupled to the processing element. For example, a wireless interface chip may consist of radio frequency (RF) elements, a microcontroller, and a memory, all bundled into a single module or a single integrated circuit (IC). The module has at least an interface port that enables operation of the module, such as through use of a command-interface to the embedded microcontroller. The microcontroller is responsible for supporting and controlling the application-specific elements. A usage of such a module typically requires a secondary microcontroller, also referred to as an application controller, to control the module and other elements therein. This is achieved through utilization of a user-developed code that runs the application controller.

An exemplary conventional architecture of a module 100 is shown in FIG. 1. The module 100 comprises a processing unit 110 that is connected via an interface or a bus 140 to its respective application memory 120. In other cases, the bus 140 is implemented as a first bus connecting between the processing unit 110 to the application memory 120 and a second bus connecting between the processing unit 110 to the user controller and memory 150.

An input/output (IO) and peripherals unit 130 is also connected to the interface 140 to allow special functions of the module as well as access to external elements of the module. A user controller and memory 150 (the application controller mentioned hereinabove) may be connected to the module 100, either directly to the interface 140 or via unit 130. It should be noted that, in certain cases, the unit 150 is a separate unit from the module 100, but in some implementations, the unit 150 and the module 100 are integrated into a single IC.

One of ordinary skill in the art should realize that, typically, the application memory 120 is not fully utilized. As shown in the enlargement section where there are two areas of memory, a used portion of the memory 124 and an unused portion of the memory 122. In many of today's applications, the processing unit 110 is powerful enough to execute both the application code of the module 100 as well as user code provided by a user of the module, where the user code is code provided by a user which may be code compiled from a high level programming language such as C, C++, and the like, or even provided in assembly or machine code, and provides additional customization to operation of the module. However, providers of the module 100 (and similar modules) are concerned about the uncontrolled nature of the code provided by the user. Namely, the user may provide code, especially code developed in languages, such as Assembly, C, and C++ that, as a result of an error or careless programming, results in the corruption of the embedded application code and data stored in the used application memory portion 124. As this is an undesirable result, designer of the module 100 refrain from allowing users with access to the application memory 120 and require the architecture discussed with reference to FIG. 1. Alternatively, the user-provided code must be provided for compilation with the embedded application, which is inefficient at best, and potentially exposes the user code to the provider of the embedded code.

It would therefore be advantageous to provide a solution which would be robust in reacting to attempts by a user to deliberately or inadvertently reach memory portions of an embedded memory of a module, such as module 100. It would further be advantageous if such a solution would allow the use of commonly used programming languages.

### SUMMARY

Certain exemplary embodiments disclosed herein include a method for a software development kit (SDK) operative on a computing system is provided. The method comprises receiving at least a portion of a code in a managed programming language; receiving at least memory parameters of a target processing system, wherein the memory parameters define a memory space available for a compiled code of the received code; and compiling, using the memory parameters, the received code in the managed programming language into a native code for execution by the target processing system, wherein the compiled native code is forced to execute within boundaries defined by the memory parameters.

Certain exemplary embodiments disclosed herein further include an embedded controller. The embedded controller comprises a processing unit; a memory connected to the processing unit, wherein the memory comprises a first portion containing embedded code for execution by the processing unit, wherein the memory further comprises a second portion available for loading compiled code of a code in a managed language, wherein the memory further comprises at least memory parameters; and an interface for loading compiled code in the second portion of the memory, wherein the compiled code is forced to execute within boundaries of the second portion of the memory.

Certain exemplary embodiments disclosed herein further include apparatus that comprises a processing unit; an interface to a target processing system; and a memory coupled to the processing unit and containing therein instructions for execution by the processing unit that when executed configures the apparatus to: receive at least a portion of a code in a managed programming language; receive at least memory parameters of a target processing system, wherein the memory parameters define a memory space available for a compiled code of the received code; and compile, using the memory parameters, the received code in the managed programming language into a native code for execution by the target processing system, wherein the compiled native code is forced to execute within boundaries defined by the memory parameters.

### BRIEF DESCRIPTION OF THE DRAWINGS

The subject matter disclosed herein is particularly pointed out and distinctly claimed in the claims at the conclusion of the specification. The foregoing and other objects, features and advantages of the disclosed embodiments will be apparent from the following detailed description taken in conjunction with the accompanying drawings.

FIG. 1 is a schematic diagram of an embedded system.

FIG. 2 is a schematic diagram of an embedded system having a memory that is shared between embedded code and data, as well as user code and data according to an embodiment.

FIG. 3 is a flowchart for compilation of a user managed language to be executed by a target embedded system sharing memory between the embedded code and data as well as the user code and data according to one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments include a system and method operative on a software development kit (SDK) that allow the sharing of unused memory available of embedded processing systems. Managed language, also referred to as managed code, is compiled so as to execute and use memory of the target embedded processor without exceeding the boundaries of the memory allocated for the user application. The utilization of SDK managed language, rather than other languages, such as C and C++ guarantees that the defined boundaries of the allocated memory are not exceeded. Thus, the SDK ensures that the user code does not pose any threat of conflict with the native code and data operated by the target embedded processing system, thereby providing an advantage over prior art SDKs for embedded applications. The native code is a code to executed by a particular processor (e.g., processing unit 110) of the embedded processing system (e.g., system 200), wherein the native code may be a specific instruction set designed for the particular processor or, an industry known native code (e.g., native code for microcontrollers such as 8051/2 from Intel®, ARM microcontrollers, etc.).

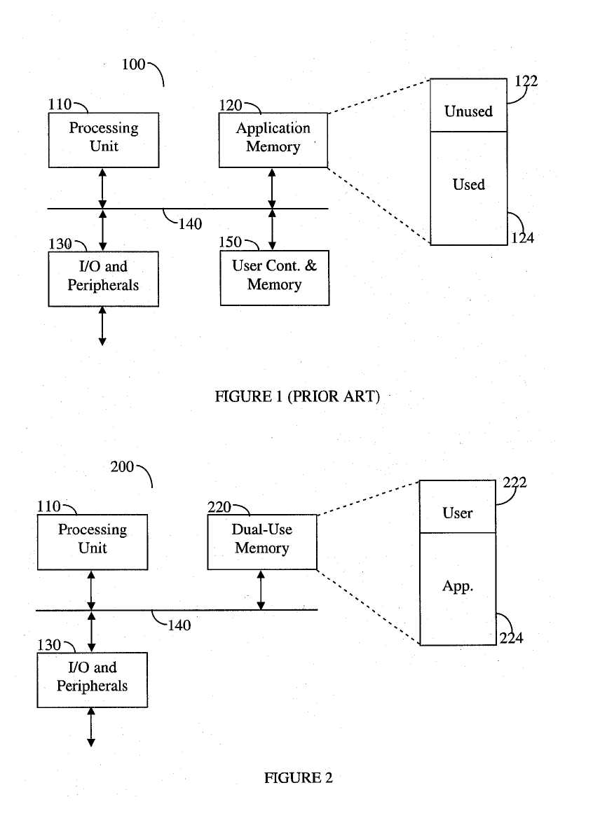

FIG. 2 depicts an exemplary and non-limiting schematic diagram of an embedded processing system 200 according to one embodiment. The embedded processing system 200, for example a wireless interface device, comprises a processing unit 110 connected to a dual use memory 220 via an interface or bus 140. According to various disclosed embodiments, the dual use memory 220 is shared between embedded code and data and user code and data. An input/output (IO) and peripherals unit 130 is also connected to the interface or bus 140 to allow special functions of the module as well as access to external elements of the module.

Unlike conventional architecture discussed above (with reference to FIG. 1), where unused memory must remain unused in order to prevent accidental overrides in the memory, the memory 220 provides a shared area between the user code and data 222, thereby allowing utilization of memory areas not used by the embedded application, and an application memory area 224 where code and data of the embedded application resides. This is achieved by identifying the memory boundaries of the embedded code and data for the SDK and allowing for the use of the remaining memory area to be used in a controlled manner by the user code and data. According to one embodiment, a user can cause the loading of code to the user memory area 222 provided that the code was prepared as further explained herein below, i.e., using a managed programming language where memory boundaries are explicitly provided and guaranteed to be adhered to. As a result, the need for an additional microcontroller and memory as required by conventional solutions is overcome and, therefore, a more cost and power efficient solution is provided.

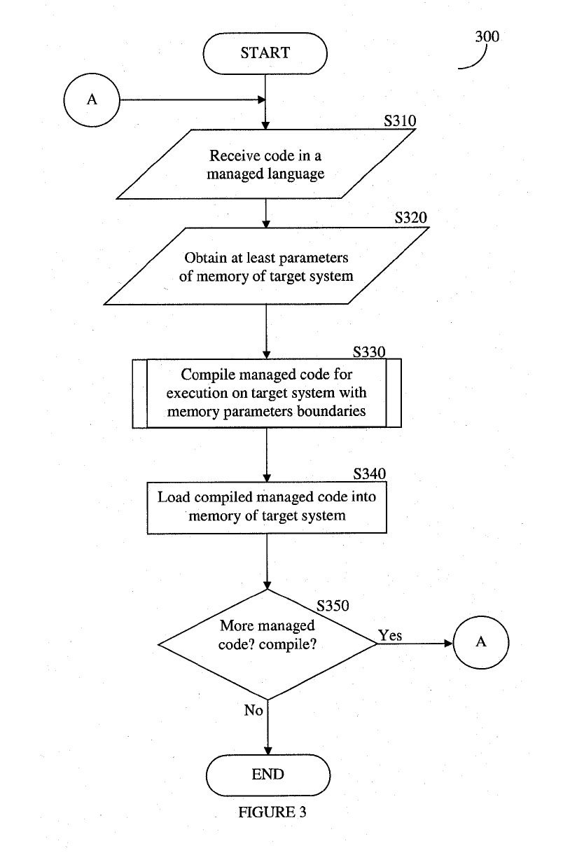

FIG. 3 shows an exemplary and non-limiting flowchart 300 for compilation of a user-managed language to be executed by a target embedded processing system sharing memory between the embedded code and data and the user code and data. Managed programming languages such as C#, Java, F#, VB.net, C++.net, J#, PowerShell, Axum, A#, Boo, Cobra, M, Oxygene, IronScheme, IronPython, IronRuby, Nemerle, Phalanger, P#, Scala, and the like are used to create managed intermediate code such as Microsoft Intermediate Language (MSIL), ByteCode, and the like. This includes, but is not limited to, all languages that are based on the “Common Language Infrastructure” (CLI) standard (ECMA-335).

In S310, code in a managed programming language is received from the user. The code may be received from an external memory, entered by the user through a user interface, or by other ways which are known in the art. Managed languages, such as C# or Java, are compiled to an intermediate language, such as Microsoft® intermediate language (MSIL) or byte-code, respectively, that is run on a virtual-machine, and compiled to a native language at run-time for just-in-time (JIT) use. They are referred to as managed because the memory is managed such that unlike, for example, C or C++, managed languages do not enable direct access of memory locations (e.g., pointers), thereby making managed languages memory-safe. Additionally, a virtual-machine usually contains a garbage-collector to prevent memory leaks. In one embodiment, in order to use unsafe code received by the SDK from the user, a special keyword is used in source-code and is also represented in the output binary code. Support of this feature, for example in a virtual machine, is typically resource-intensive. The solution to this will be described herein below in greater detail.

In S320, parameters respective of the memory available on a target embedded system memory are obtained. This step is necessary since the parameters are required for compilation of the received code in a managed language within the allowed boundaries of memory. The parameters may be provided by the user of the SDK, or by analyzing the size and location of the embedded code and data already used by the module. For example, in an embodiment, the parameters may include the size of portion 224 of the memory and its starting address. Alternatively, in another embodiment, the start address and the end address of the memory portion 224 may be provided. In yet another embodiment the start address and size of memory portion 222 may be provided as parameters. Therefore, the parameters ensure that the memory available on a target embedded system memory is not outside of the boundaries of the memory portion 224.

In S330, the received user code is compiled by the SDK for execution on the target system while taking into account at least the boundaries of the memory to be used (respective of the parameters provided or otherwise obtained). In an embodiment the received user code is compiled into a native code of the processing unit (e.g., unit 110) of the embedded processing system (e.g., system 200). Unlike in the case of a virtual machine JIT approach, according to the disclosed embodiments, a static, ahead-of-time compilation of managed MSIL or byte-code into native object code occurs.

In an embodiment, the static, ahead-of-time compilation provides at least the following traits that overcome limitations of the prior art: (a) very little or no overhead in terms of code-size (footprint) to accommodate; and (b) no overhead of runtime-compilation in terms of processing resources and ram. This compilation process adds all functions and elements that are necessary to reproduce the required functions of the virtual machine to the object-code as inline-code, thereby avoiding the virtual machine approach. For example, consider a garbage collection process where a reference count is performed in the same code-thread, and background and objects are freed as part of the ref decrease routine. Therefore, the use of a background-worker, as would be typical for a virtual machine, would not be necessary. As noted above, since managed language code has no physical access to memory it is possible to verify the memory-space used by the code. Furthermore, memory safety guarantees prevention of unwanted cases of buffer overruns and the like. One of ordinary skill in the art should readily realize that this is true so long as no unsafe code is used. However, due to the inherent structure of the managed language, any unsafe code is marked so in binary. According to one embodiment, such unsafe code will not be allowed by the compiler.

Returning to FIG. 3, in optional S340 the compiled code is loaded into the memory 220 of the target embedded system 200, for example via unit 130. The compiled code is loaded into the user memory area 222 according to one embodiment. It should be noted that S340 may further include or otherwise provide for storing of the compiled code in a memory of an SDK. In S350 it is checked whether it is necessary to compile additional code and, if so, execution continues with S310; otherwise, execution terminates.

The embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The above description of the disclosed embodiments is illustrative, and is not intended to be limiting. It will thus be appreciated that various additions, substitutions and modifications may be made to the above described embodiments without departing from the scope of the disclosed embodiments. Accordingly, the scope of the disclosed embodiments should be construed in reference to the appended claims.

What is claimed is:

1. A computerized method for a software development kit (SDK) operative on a computing system, comprising:
receiving at least a portion of a code in a managed programming language;
receiving at least memory parameters of a target processing system, wherein the memory parameters define a memory space available for a compiled code of the received code; and
compiling, using the memory parameters, the received code in the managed programming language into a native code for execution by the target processing system, wherein the compiled native code is compiled to execute solely within boundaries defined by the memory parameters.

2. The computerized method of claim 1, wherein the managed language is any one of: byte code, Java code, and C# code.

3. The computerized method of claim 1, wherein the memory parameters define at least an area in a memory of the target processing system which to be safely used by the compiled code.

4. The computerized method of claim 1, further comprising:
loading the compiled code into a memory of the target processing system.

5. The computerized method of claim 1, wherein the target processing system is an application-specific module.

6. The computerized method of claim 1, wherein compiling the received code further comprising:
identifying unsafe code as indicated in the compiled code; and
notifying of a compilation error.

7. An apparatus comprising:
a processing unit;
an interface to a target processing system; and
a memory coupled to the processing unit and containing therein instructions for execution by the processing unit that when executed configures the apparatus to:
receive at least a portion of a code in a managed programming language;
receive at least memory parameters of a target processing system, wherein the memory parameters define a memory space available for a compiled code of the received code; and
compile, using the memory parameters, the received code in the managed programming language into a native code for execution by the target processing system, wherein the compiled native code is compiled to execute solely within boundaries defined by the memory parameters.

8. The apparatus of claim 7, wherein the managed language is any one of: byte code, Java code, and C# code.

9. The apparatus of claim 7, wherein the memory parameters define at least an area in a memory of the target processing system which be safely used by the compiled code.

10. The apparatus of claim 7, wherein the apparatus is further configured to load the compiled code into a memory of the target processing system.

11. The apparatus of claim 7, wherein the target processing system is an application-specific module.

12. The apparatus of claim 7, wherein the apparatus is further configured to:
identify unsafe code as indicated in the compiled code; and
notify of a compilation error upon such identification.

13. An embedded controller comprising:
a processing unit;
a memory connected to the processing unit, wherein the memory comprises a first portion containing embedded code for execution by the processing unit, wherein the memory further comprises a second portion available for loading compiled code of a code in a managed language, wherein the memory further comprises at least memory parameters; and
an interface for loading compiled code in the second portion of the memory, wherein the compiled code is compiled to execute solely within boundaries of the second portion of the memory.

14. The embedded controller of claim 13, wherein the managed language is any one of: byte code, Java code, and C# code.

15. The embedded controller of claim 13, wherein the memory parameters define at least the boundaries of the second portion of the memory.

16. The embedded controller of claim 13, wherein the embedded controller is an application-specific module.
